(19) United States
(12) Patent Application Publication
(10) Pub. No.: US 2013/0310081 A1
(43) Pub. Date: Nov. 21, 2013

(54) INDOOR POSITIONING SERVICE SYSTEM USINGBEACON NODES

(71) Applicant: WINITECH CO., LTD., Daegu (KR)

(72) Inventor: Kyo Koan CHU, Daegu (KR)

(73) Assignee: WINITECH CO., LTD., Daegu (KR)

(21) Appl. No.: 13/773,412

(22) Filed: Feb. 21, 2013

(30) Foreign Application Priority Data
May 18, 2012 (KR) 10-2012-0052936

(51) Int. Cl. H04W 4/02

(52) U.S. Cl. CPC H04W 4/025
USPC 455/456.3

(57) ABSTRACT

An indoor positioning service system using beacon nodes includes beacon nodes, an indoor location information provision server, an indoor/outdoor continuous location information server, an indoor space information server, and an integrated service provision server. The beacon nodes are installed and periodically transmit sensing data. The location information provision server detects locations and provides location information. The continuous location information server continuously detects a location of a smart phone user and continuously provides location information thereof. The indoor space information server provides requested information of the building among stored 3-Dimension (3D) information of indoor space information of the building. The integrated service provision server provides information about a requested service, based on the provided information.

### CROSS REFERENCES

This application claims the benefit of Korean Patent Application No. 10-2012-0052936, filed 18 May 2012, which is hereby incorporated by reference in its entirety into this application.

### BACKGROUND OF THE INVENTION

1. Field of the Invention

The present invention relates to an indoor positioning service system. More particularly, the present invention relates to an indoor positioning service system using beacon nodes, for providing a location information service by installing the beacon nodes in fire-fighting facilities, electric facilities and the like within a building.

2. Description of the Related Art [Para 3] Generally, positioning methods in a restricted space, particularly, within doors have been attempted variously according to their application scopes and objects. The basis of them is a distance measurement technology, and physical technologies using ultrasonic waves and electromagnetic waves have been used widely.

The ultrasonic waves are excellent in security because they do not go through a wall, and are free in frequency choice, and are realized cheaply, while having a disadvantage that they have a relatively short effective distance, and are vulnerable to a multi path phenomenon, and have many generation sources capable of causing interference.

In the case of the electromagnetic waves, there are several positioning methods depending on a frequency range. As recently standardized Wireless Personal Area Network (WPAN) standards deal sections relating to distance measurement, the positioning methods using the electromagnetic waves are attracting attention. By applying distance information obtained from distance measurement to a trilateration or multilateration technology, the positioning methods can calculate location information of a mobile tag. But, this needs fixed reference nodes and, to obtain one location, three reference nodes are basically required around the location. To realize this, three reference nodes should be installed in suitable locations of spots needing positioning, and a problem is caused in which the number of reference nodes cannot help but to increase according to an area of a spot intended for positioning.

Meantime, due to the recent popularization of smart phones, the growth of mobile communication networks, and the spreading of Wireless Local Area Networks (WLANs), various services could be provided to users using Internet freely without the limitation of time and space. Among the services provided to the users, a Location Based Service (LBS) is diversely applied as a bus or subway arrival time service, a navigation service and the like to provide information suitable to several purposes.

To provide the location based service to the users, work of obtaining accurate location information of a user or object substance is required. In the case of an outdoor environment, the location based service can acquire the accurate location information using a Global Positioning System (GPS) with almost no error. But, in the case of an indoor environment, there is a problem that a location based service for the indoor environment is restricted as yet, because it cannot use satellite information.

### SUMMARY OF THE INVENTION

An aspect of exemplary embodiments of the present invention is to address at least the problems and/or disadvantages and to provide at least the advantages described below. Accordingly, an aspect of exemplary embodiments of the present invention is to provide an indoor positioning service system using beacon nodes for, by installing beacon nodes in fire-fighting facilities, electric facilities, signboards and the like within a building, providing a location information service for a resident, an object substance and the like within the building to a general user, a public institution, a general disaster prevention center, a facilities management institution and the like.

According to one aspect of the present invention, an indoor positioning service system using beacon nodes is provided. The indoor positioning service system includes a plurality of beacon nodes, an indoor location information provision server, an indoor/outdoor continuous location information server, an indoor space information server, and an integrated service provision server. The plurality of beacon nodes are installed in fire-fighting facilities, electric facilities, and signboards within a building and periodically transmit sensing data. The indoor location information provision server detects locations of residents and the fire-fighting facilities within the building through the sensing data received from the plurality of beacon nodes, and provides location information of the residents and the fire-fighting facilities. When a smart phone user using a Location Based Service (LBS) moves from the outside of the building to an indoor space of the building, the indoor/outdoor continuous location information server continuously detects a location of the smart phone user and continuously provides location information of the smart phone user. The indoor space information server provides requested information of the building among stored 3-Dimension (3D) information of indoor space information of the building where the beacon nodes are installed. The integrated service provision server provides information about a service requested by a location service requestor or a public institution, based on the information provided in the indoor location information provision server, the indoor/outdoor continuous location information server, and the indoor space information server. The beacon nodes are piezoelectric type beacon nodes that are installed in specific positions of a floor within the building to sense a movement of the resident within the building.

### BRIEF DESCRIPTION OF THE DRAWINGS

The above and other objects, features and advantages of the present invention will become more apparent from the following detailed description when taken in conjunction with the accompanying drawings in which:

FIG. 1 is a schematic conceptual diagram illustrating a service configuration of an indoor positioning service system for applying an exemplary embodiment of the present invention;

FIG. 2 is a schematic block diagram illustrating a construction of an indoor positioning service system using beacon nodes according to an exemplary embodiment of the present invention;

FIG. 3 is a schematic example diagram illustrating a location information collection process using piezoelectric type beacon nodes among beacon nodes according to an exemplary embodiment of the present invention;

FIG. 4 is an example diagram illustrating information displayed on a screen of a smart phone when a user moves from the outside to the inside according to an exemplary embodiment of the present invention;

FIG. 5 is an example diagram illustrating information displayed on a screen of a designated terminal of a facilities management institution according to an exemplary embodiment of the present invention;

FIG. 6 is an example diagram illustrating information displayed on a screen of a terminal of a general disaster prevention center according to an exemplary embodiment of the present invention; and

FIG. 7 is an example diagram illustrating a screen providing evacuation information to an evacuee according to an exemplary embodiment of the present invention.

Throughout the drawings, the same drawing reference numerals will be understood to refer to the same elements, features and structures.

### DETAILED DESCRIPTION OF THE INVENTION

Exemplary embodiments of the present invention will now be described in detail with reference to the annexed drawings.

In the following description, well-known functions or constructions are not described in detail since they would obscure the invention in unnecessary detail.

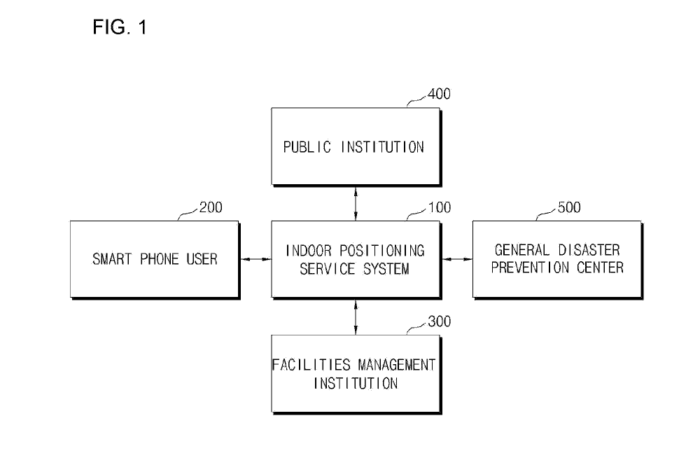

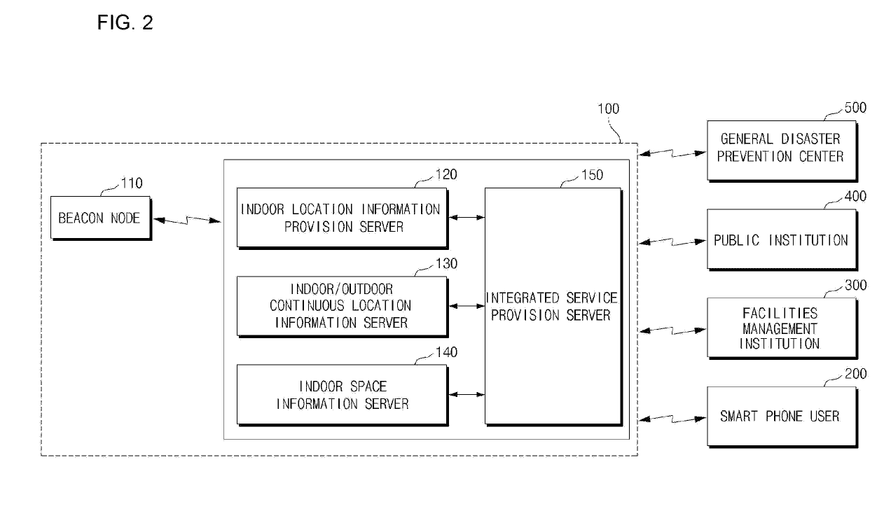

FIG. 1 is a schematic conceptual diagram illustrating a service configuration of an indoor positioning service system for applying an exemplary embodiment of the present invention. FIG. 2 is a schematic block diagram illustrating a construction of an indoor positioning service system using beacon nodes according to an exemplary embodiment of the present invention.

As illustrated in FIGS. 1 and 2, the indoor positioning service system 100 for applying the present invention includes beacon nodes 110, an indoor location information provision server 120, an indoor/outdoor continuous location information server 130, an indoor space information server 140, and an integrated service provision server 150.

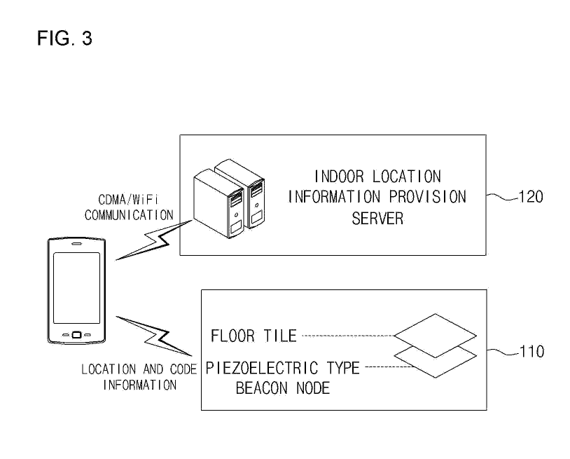

The beacon nodes 110 are installed in fire-fighting facilities, electric facilities, and signboards within a building and periodically transmit sensing data (including location information of each beacon node and unique code information thereof) to the indoor location information provision server 120. As illustrated in FIG. 3, the beacon nodes 110 include piezoelectric type beacon nodes that are installed in specific positions of a floor within the building to sense a movement of a resident within the building.

The indoor location information provision server 120 detects locations of residents and fire-fighting facilities within a building through sensing data received from the beacon node 110, and provides location information of the residents and fire-fighting facilities to the integrated service provision server 150.

When a smart phone user 200 using a Location Based Service (LBS) moves from the outside of a building to an indoor space of the building, the indoor/outdoor continuous location information server 130 continuously detects a location of the smart phone user 200 and continuously provides location information of the smart phone user 200 to the smart phone user 200 and the integrated service provision server 150.

The indoor space information server 140 provides the integrated service provision server 150 with requested information of a building among stored 3-Dimension (3D) information of indoor space information of the building where the beacon nodes 110 are installed.

The integrated service provision server 150 provides information about a service requested by a location service requestor or a public institution, based on the information provided from the respective servers 120 to 140.

An operation process of the aforementioned indoor positioning service system according to an exemplary embodiment of the present invention is described below in detail with reference to the accompanying drawings.

To provide an indoor positioning service as illustrated in FIGS. 1 and 2, preceding work is needed.

First, the beacon nodes 110 are installed in fire-fighting facilities (e.g., fire detectors, exit lights, guide lights and the like), electric facilities (e.g., illumination lights, wall outlets and the like), and signboards within a building. In an exemplary embodiment, as illustrated in FIG. 3, piezoelectric type beacon nodes installed in specific locations of a floor within the building to sense a movement of a resident within the building can be used as well.

Further, the indoor space information server 140 stores 3D information of indoor space information of a building where the beacon nodes 110 are installed. If there is a request for the 3D information of the building, the indoor space information server 140 provides the 3D information of the building to the integrated service provision server 150.

After the preceding work is completed, if the resident within the building is located near the beacon node 110 installed in the fire-fighting facilities, the electric facilities, the signboard and the like, the corresponding beacon node 110 periodically transmits sensing data (including location information of each beacon node and unique code information thereof) to the indoor location information provision server 120. At this time, if the resident within the building steps on a floor tile, a piezoelectric type beacon node underlying the floor tile transmits sensing data (including location information of the piezoelectric type beacon node and unique code information thereof) to the indoor location information provision server 120.

The indoor location information provision server 120 detects a location of a resident within a building through sensing data received from the beacon node 110, and provides location information of the resident to the integrated service provision server 150.

Also, if the smart phone user 200 using the location based service moves from the outside of a building to an indoor space of the building, the indoor/outdoor continuous location information server 130 continuously detects a location of the smart phone user 200, and provides location information of the smart phone user 200 to the smart phone user 200 and the integrated service provision server 150.

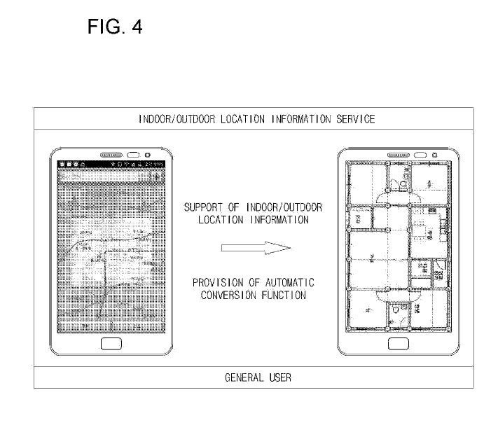

In an exemplary embodiment, as illustrated in FIG. 4, the moment the smart phone user 200 moves from the outside of a building to an indoor space of the building during a location information service, the integrated service provision server 150 receives information about the indoor space of the building from the indoor space information server 140 and automatically converts the indoor space information into an indoor drawing of a mobile application.

After that, if the smart phone user 200 makes request for an indoor navigation service, the integrated service provision server 150 displays a location of the smart phone user 200 on the indoor drawing of the mobile application in real-time.

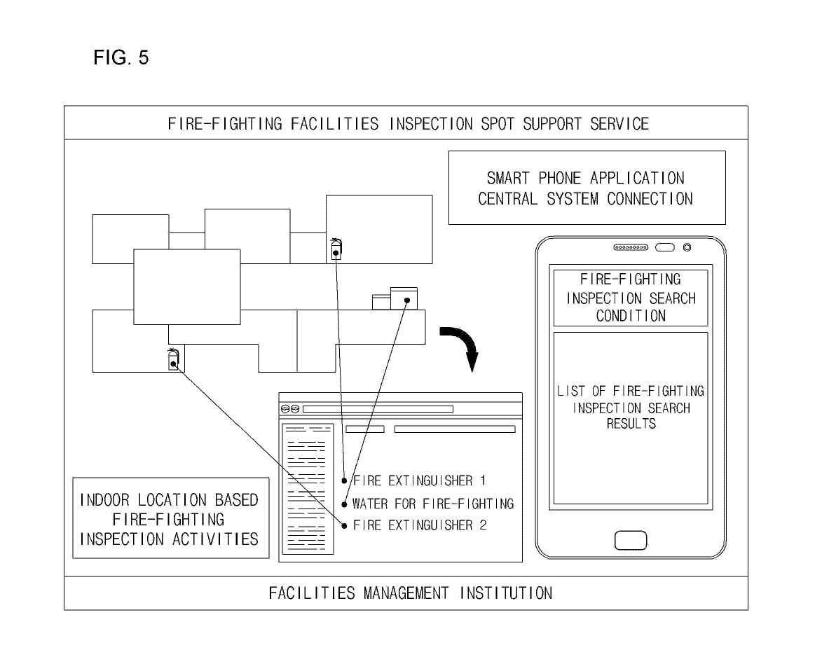

Further, the integrated service provision server 150 provides a service of displaying information about a location of fire-fighting facilities located within a building, on a designated terminal of the facilities management institution 300. In an exemplary embodiment, as illustrated in FIG. 5, when displaying the location of the fire-fighting facilities on the designated terminal of the facilities management institution 300, the integrated service provision server 150 displays an indoor drawing and a list of fire-fighting inspection search results together.

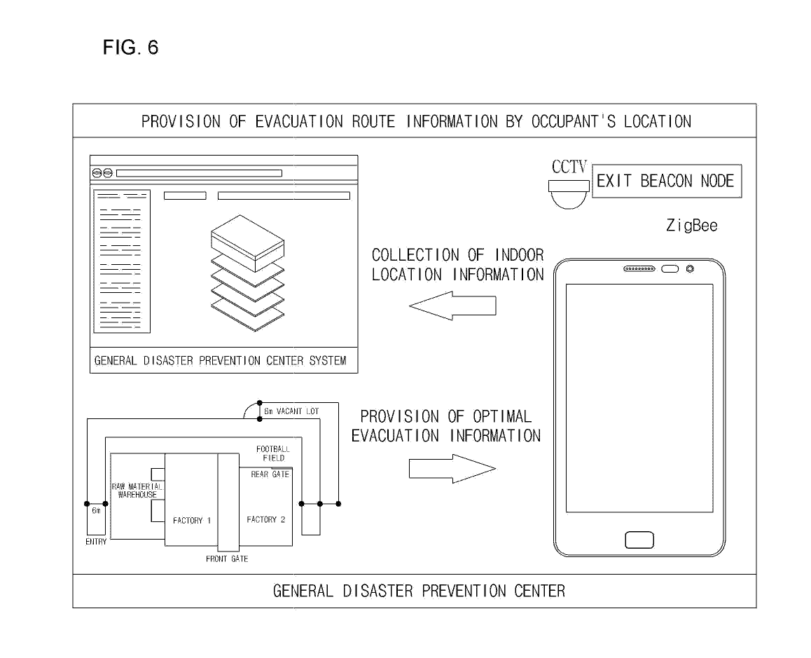

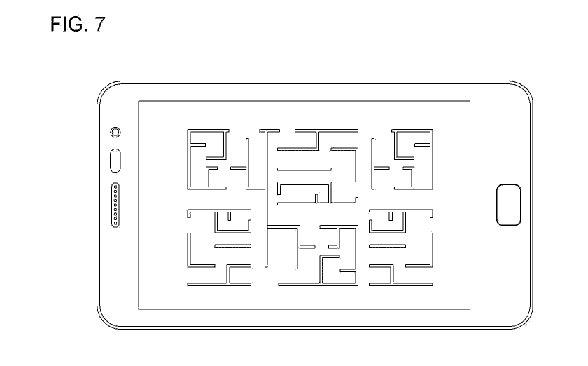

Further, as illustrated in FIG. 6, upon fire occurrence, the integrated service provision server 150 provides fire occurrence location information from fire-fighting facilities located within a building to a public institution 400 and a general disaster prevention center 500, and provides evacuation information to evacuees within the building. In an exemplary embodiment, when providing the evacuation information to the evacuees within the building, as illustrated in FIG. 7, the integrated service provision server 150 displays an evacuation route that is the closest to a location of the evacuee on the indoor drawing of the mobile application.

Meantime, the integrated service provision server 150 maps location information of the beacon node 110 and an evacuation route of a resident within doors and real-time monitors an error or non-error of a corresponding beacon node to display a positioning impossibility warning and a malfunction warning to a manager.

As described above, an indoor positioning service system using beacon nodes according to the present invention has an effect of, although a smart phone user moves from the outdoor to the indoor, being capable of continuously using a location based service and making inspection of fire-fighting facilities easier and, although emergencies such as fire occurrence and the like occur, rapidly coping with the emergencies.

While the invention has been shown and described with reference to a certain preferred embodiment thereof, it will be understood by those skilled in the art that various changes in form and details may be made therein without departing from the spirit and scope of the invention as defined by the appended claims.

What is claimed is:

1. An indoor positioning service system using beacon nodes, the system comprising:
a plurality of beacon nodes installed in fire-fighting facilities, electric facilities, and signboards within a building and periodically transmitting sensing data;
an indoor location information provision server for detecting locations of residents and the fire-fighting facilities within the building through the sensing data received from the plurality of beacon nodes, and providing location information of the residents and the fire-fighting facilities;
an indoor/outdoor continuous location information server for, when a smart phone user using a Location Based Service (LBS) moves from the outside of the building to an indoor space of the building, continuously detecting a location of the smart phone user and continuously providing location information of the smart phone user;
an indoor space information server for providing requested information of the building among stored 3-Dimension (3D) information of indoor space information of the building where the beacon nodes are installed; and
an integrated service provision server for providing information about a service requested by a location service requestor or a public institution, based on the information provided in the indoor location information provision server, the indoor/outdoor continuous location information server, and the indoor space information server,
wherein the beacon nodes are piezoelectric type beacon nodes that are installed in specific positions of a floor within the building to sense a movement of the resident within the building.

2. The system of claim 1, wherein the sensing data comprises location information of each beacon node and unique code information thereof.

3. The system of claim 1, wherein the integrated service provision server real-time displays a location of the smart phone user on an indoor drawing of a mobile application to provide an indoor navigation service.

4. The system of claim 1, wherein the integrated service provision server provides a service of displaying information about the location of the fire-fighting facilities located within the building on a designated terminal of the facilities management institution.

5. The system of claim 4, wherein, when displaying the location of the fire-fighting facilities on the designated terminal, the integrated service provision server displays an indoor drawing and a list of fire-fighting inspection search results together.

6. The system of claim 1, wherein, upon fire occurrence, the integrated service provision server provides fire occurrence location information from the fire-fighting facilities located within the building to a corresponding public institution, and provides evacuation information to an evacuee within the building.

7. The system of claim 6, wherein, when providing the evacuation information to the evacuee, the integrated service provision server displays an evacuation route that is the closest to a location of the evacuee on an indoor drawing on a mobile application.

8. The system of claim 1, wherein the integrated service provision server maps location information of the beacon node and an evacuation route of a resident within doors, and monitors an error or non-error of the beacon node in real-time.

9. The system of claim 1, wherein, the moment the smart phone user moves from the outside of the building to the indoor space of the building during a location information service, the integrated service provision server receives information about the indoor space of the building from the indoor space information server and automatically converts the received indoor space information into an indoor drawing of a mobile application.
